(19) United States
(12) Patent Application Publication
(10) Pub. No.: US 2018/0051839 A1
(43) Pub. Date: Feb. 22, 2018

(54) WALL SOCKET

(71) Applicant: WATER SOCKET LTD., BAT YAM (IL)

(72) Inventor: SHLOMO KANIZO, BAT YAM (IL)

(21) Appl. No.: 15/554,258

(22) PCT Filed: Feb. 24, 2016
(86) PCT No.: PCT/IL2016/050211

§ 371 Date: Aug. 29, 2017

(30) Foreign Application Priority Data
Mar. 3, 2015 (IL) 237545

(51) Int. Cl. F16L 37/60; F16L 37/098; E03C 1/02

(52) U.S. Cl. CPC F16L 37/60; E03C 1/021; F16L 37/0982

(57) ABSTRACT

A wall socket (10), comprising: an inlet (64A), for connecting an inlet pipe (20A) thereto! a first push-to-release pipe-joint (16B), comprising an outlet (64B), for pushing thereinto an outlet pipe (20B), for connecting the outlet pipe (20B) thereto! a panel (12) disposed between the inlet (64A) and the outlet (64B), and extending from the first push-to-release pipe-joint (16B); and installation means (56) for installing the panel (12) to the building wall (50), attached thereto and parallel thereto, thereby disposing the inlet (64A) behind the building wall (50, and the outlet (64B) in front of the building wall (50), thereby allowing providing a removable supply to an implement (40) by the pressing of the outlet pipe (20B) into the wall socket (10), and thereby the wall socket (10) non-significantly protrudes out of the building wall (50).

### TECHNICAL FIELD

The present invention relates to the field of sockets of a wall building.

### BACKGROUND ART

Sockets of wall buildings include electrical wall sockets. The wall sockets substantially do not protrude out of the wall, and thus they form part of the building.

Thus, electrical wall sockets are spread all over the walls, even if the implements are not currently connected thereto. The implements are connected and removed by quick connections.

In contrast to electrical infrastructure, water or gas supply sources do not form part of the building. Implements consuming water or gas are rigidly fixed to the supply sources. For an example, a tap is not removably connected to the wall.

It is an object of the present invention to provide a an apparatus for removably connecting a water or gas consumer to the wall.

It is an object of the present invention to provide a solution to the above-mentioned and other problems of the prior art.

Other objects and advantages of the invention will become apparent as the description proceeds.

### SUMMARY OF THE INVENTION

Thus, the present invention is directed to a wall socket (10), comprising:
an inlet (64A), for connecting an inlet pipe (20A) thereto;
a first push-to-release pipe-joint (16B), comprising an outlet (64B), for pushing thereinto an outlet pipe (20B), for connecting the outlet pipe (20B) thereto;
a panel (12) disposed between the inlet (64A) and the outlet (64B), and extending from the first push-to-release pipe-joint (16B); and
installation means (56) for installing the panel (12) to the building wall (50), attached thereto and parallel thereto, thereby disposing the inlet (64A) behind the building wall (50, and the outlet (64B) in front of the building wall (50),
wherein the first push-to-release pipe-joint (16B) comprises a joint for connecting the water pipe (20B) thereto by pressing the water pipe (20B) thereinto, and for releasing the water pipe (20B) therefrom by pressing a push button (22) thereof, and
wherein the panel (12) is proximate to the push button (22), thereby allowing providing a removable supply to an implement (40) by the pressing of the outlet pipe (20B) into the wall socket (10), and
thereby the wall socket (10) non-significantly protrudes out of the building wall (50).

### BRIEF DESCRIPTION OF DRAWINGS

Preferred embodiments, features, aspects and advantages of the present invention are described herein in conjunction with the following drawings:

FIG. 1 is a cross-sectional view of a prior art push-to-release pipe-joint.

FIG. 2 is a cross-sectional view of a push-to-release pipe-joint, according to one embodiment of the present invention.

FIG. 3 is a perspective view of the push-to-release pipe-joint of FIG. 2, attached to the building wall depicted in FIG. 2.

FIG. 4 is a perspective view of the push-to-release pipe-joint of FIG. 2, before being attached to the building wall of FIG. 3.

FIG. 5 is a perspective view of the push-to-release pipe-joint of FIG. 2, before being attached to the building wall of FIG. 3.

FIG. 6 is a plumbing diagram, for utilizing the wall socket of FIG. 2.

The drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

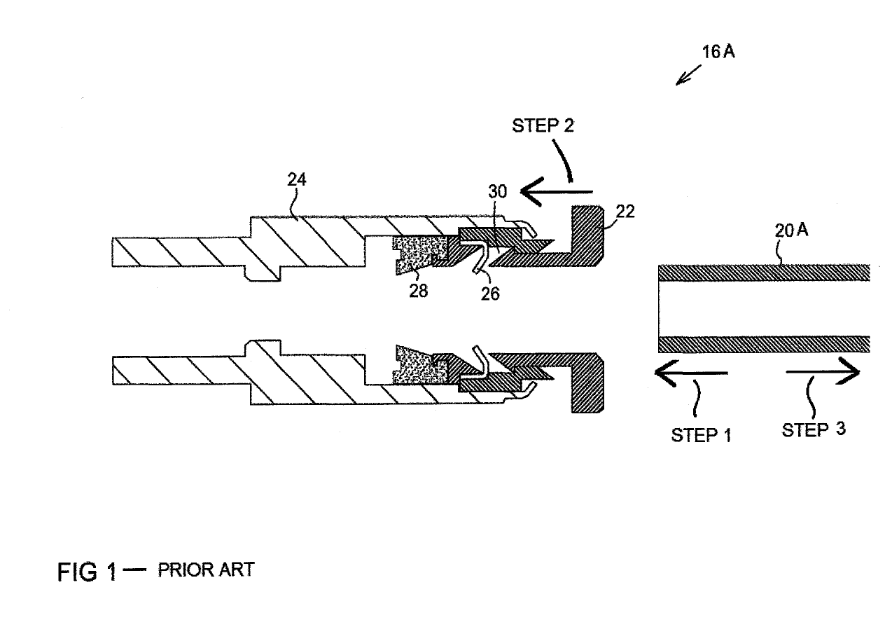

FIG. 1 is a cross-sectional view of a prior art push-to-release pipe-joint.

The term “push-to-release pipe-joint” refers herein to a joint for connecting thereto a water pipe by pressing the pipe into the joint, and for releasing the water pipe therefrom by pressing a push button thereof.

A prior art push-to-release pipe-joint 16A is intended to connect, in a quick manner, an end of a pipe 20A thereto without tools.

Pipe 20A is sealed to push-to-release pipe-joint 16A by a seal 28. At the first step, upon pressing pipe 20A to the left, pipe 20A crosses a springy hook 26 by pressing it. Springy hook 26 tacks pipe 20A, for not allowing releasing it.

For releasing pipe 20A, at the second step, the user presses a push button 22 having an end 30 being complementary to hook 26, thus pressing hook 26, for ceasing the pressure on pipe 20A. At the third step, the user may pull pipe 20A outside push-to-release pipe-joint 16A.

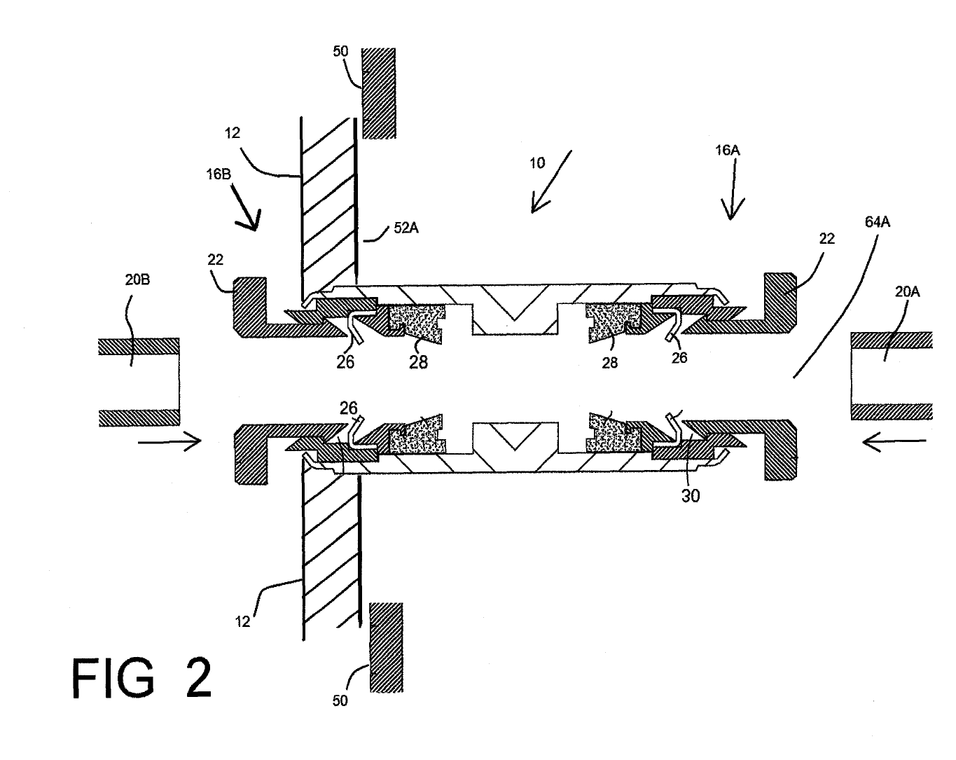

FIG. 2 is a cross-sectional view of a push-to-release pipe-joint, according to one embodiment of the present invention.

A wall socket 10 constitutes a female connector, being fixed to the building wall.

In contrast to the common female electrical wall sockets, designed for inserting male plugs thereinto, wall socket 10 constitutes a female water or gas connector, for inserting thereinto a “male” pipe.

Wall socket 10 utilizes the female character of the push-to-release pipe-joint of FIG. 1, for constituting a socket.

Wall socket 10 includes, according to one embodiment of the present invention, at least two prior art push-to-release pipe-joints 16A and 16B of FIG. 1, each facing a different direction; and a perpendicular panel 12 disposed therebetween.

Wall socket 10 is designed for connecting an inlet pipe 20A from a first direction; for connecting an outlet pipe 20B from a second direction; and for attaching perpendicular panel 12 to a building wall 50 and parallel thereto.

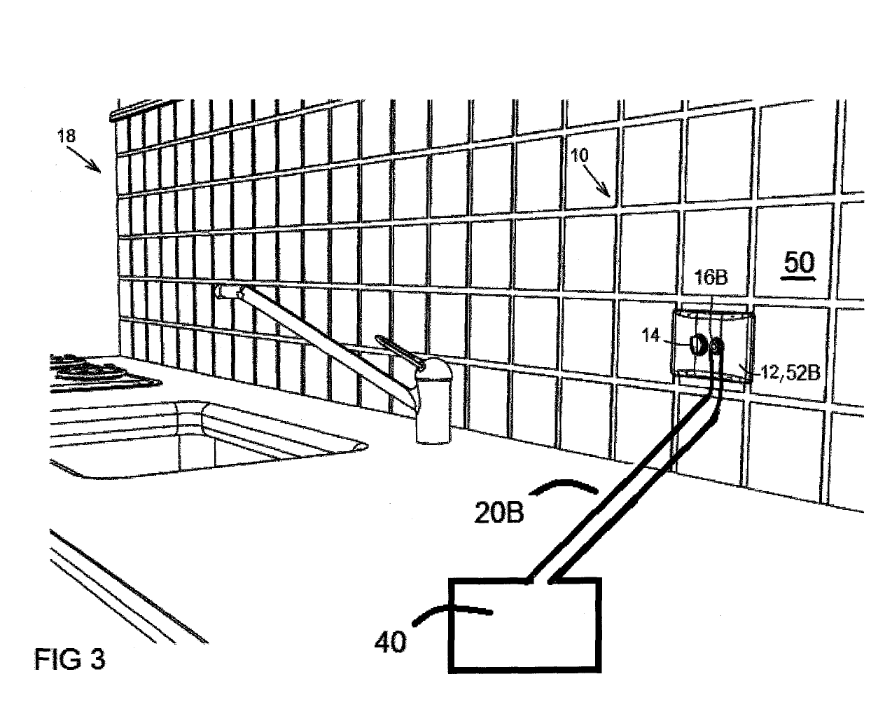

FIG. 3 is a perspective view of the push-to-release pipe-joint of FIG. 2, attached to the building wall depicted in FIG. 2.

Wall socket 10 is designed for attaching thereof to wall 50 of a kitchen or any other room 18 of a residence, for allowing a non-professional user, to connect water pipe 20B of an implement 40 to push-to-release pipe-joint 16B of wall socket 10.

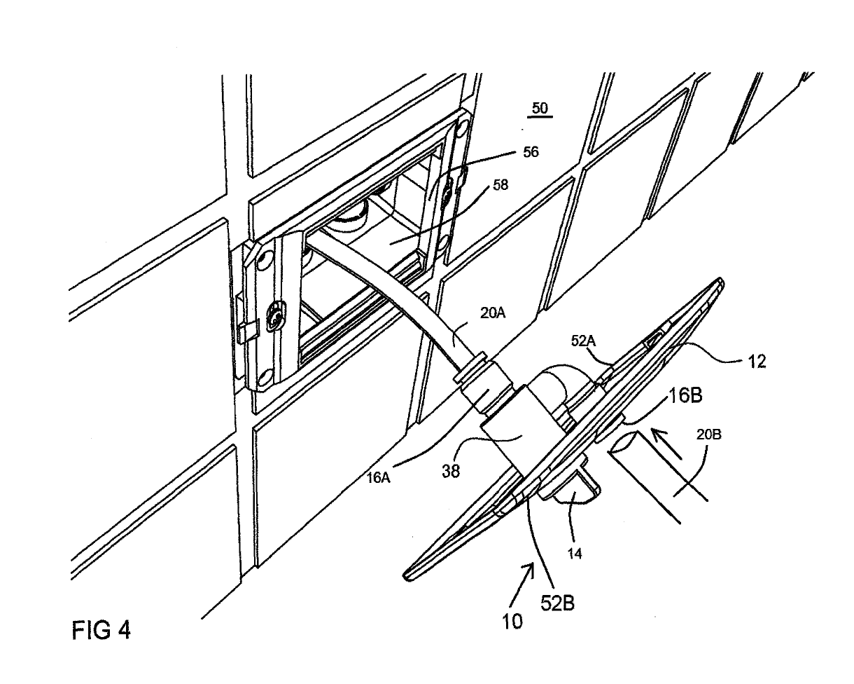

FIG. 4 is a perspective view of the push-to-release pipe-joint of FIG. 2, before being attached to the building wall of FIG. 3.

Wall socket 10 is designed for being connected, by quick connection, to an inlet pipe 20A, to be hidden behind building wall 50 by panel 12.

Panel 12 is disposed proximate to push-to-release pipe-joint 16B, thus push-to-release pipe-joint 16B minimally protrudes from wall 50.

Referring to FIG. 2, only the length of push button 22 must protrude, for allowing pressing push button 22, for allowing releasing outlet pipe 20B.

Panel 12 is rigidly fixed at least to push-to-release pipe-joint 16B, thus push-to-release pipe-joint 16B is stationary, for allowing inserting outlet pipe 20B.

Wall socket 10 preferably includes a mechanical connection box 56, to be inserted into an opening 58 in the building wall 50, and for being rigidly fixed to the opening 58. Connection box 56 is designed for connecting to panel 12 thereto by snapping means or by simple screwing means.

Wall socket 10 may include a faucet 38, for allowing or disallowing water passage from inlet pipe 20A to outlet pipe 20B. Faucet 38 may be operated by a handle 14 being disposed, like push-to-release pipe-joint 16B, on the external side 52B of panel 12.

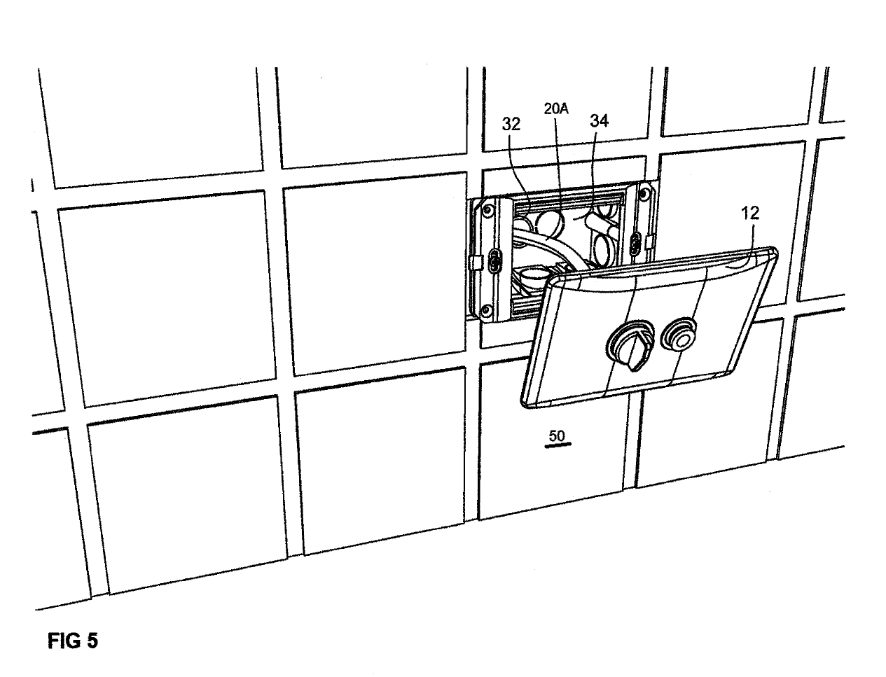

FIG. 5 is a perspective view of the push-to-release pipe-joint of FIG. 2, before being attached to the building wall of FIG. 3.

Inlet pipe 20A preferable is hidden behind building wall 50, may be threaded into a housing pipe 32.

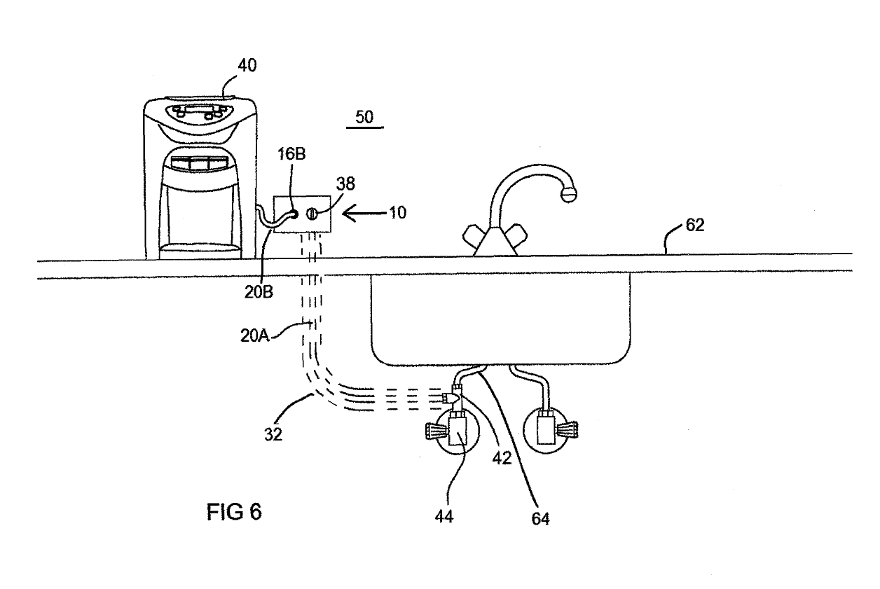

FIG. 6 is a plumbing diagram, for utilizing the wall socket of FIG. 2.

In modern kitchen topology, the water is supplied by a water supply source 44, represented by a faucet, disposed below the working surface 62, to a tap 60, laid on the working surface 62, through a pipe 64 crossing the working surface 62 through a hole in working surface.

Wall socket 10 allows supplying the water from water supply source 44, represented by a faucet, disposed below working surface 62, to implement 40, such as a minibar or a refrigerator, disposed above working surface 62, through inlet pipe 20A, without making a hole in working surface, for crossing working surface 62, since inlet pipe 20A is installed behind or within wall 50.

Inlet pipe 20A disposed behind or within building wall 50, extends from a splitting element 42, splitting the water supply from water supply source 44 to wall socket 10 installed to building wall 50.

Thus, the present invention is directed to a wall socket (10), comprising:
an inlet (64A), for connecting an inlet pipe (20A) thereto;
a first push-to-release pipe-joint (16B), comprising an outlet (64B), for pushing thereinto an outlet pipe (20B), for connecting the outlet pipe (20B) thereto;
a panel (12) disposed between the inlet (64A) and the outlet (64B), and extending from the first push-to-release pipe-joint (16B); and
installation means (56) for installing the panel (12) to the building wall (50), attached thereto and parallel thereto, thereby disposing the inlet (64A) behind the building wall (50, and the outlet (64B) in front of the building wall (50),
wherein the first push-to-release pipe-joint (16B) comprises a joint for connecting the water pipe (20B) thereto by pressing the water pipe (20B) thereinto, and for releasing the water pipe (20B) therefrom by pressing a push button (22) thereof, and
wherein the panel (12) is proximate to the push button (22), thereby allowing providing a removable supply to an implement (40) by the pressing of the outlet pipe (20B) into the wall socket (10), and
thereby the wall socket (10) non-significantly protrudes out of the building wall (50).

The inlet (64A) may comprise a second push-to-release pipe-joint (16B), for connecting the inlet pipe (20A) thereto.

The panel (12) may rigidly be fixed to the push-to-release pipe-joint (16B),
thereby the pressing of the outlet pipe (20B) into the wall socket (10) ensures the connection of the outlet pipe (20B) into the first push-to-release pipe-joint (16B).

The inlet (64A) may comprise a water inlet, and the outlet (16B) may comprise a water outlet, thereby allowing providing water supply to the implement (40).

The inlet pipe (20A) is to be disposed behind the building wall (50),
thereby allowing supplying water from a water source (44) disposed below a working surface (62), to the implement (40) disposed above the working surface (62), through the inlet pipe (20A), without making a hole in the working surface (62).

The installation means (56) for installing the panel (12) to the building wall (50), attached thereto and parallel thereto, may comprise a connection box (56), for being inserted into an opening (58) in the building wall (50).

The wall socket (10) may further comprise:
a faucet (38) for allowing passage from the inlet (64A) to the outlet (64B).

The wall socket (10) may further comprise:
a handle (14) for operating the faucet (38),
wherein the panel (12) is disposed between the inlet (64A) and the handle (14),
thereby the handle (14) is accessible upon installation of the wall socket (10) to the building wall (50).

In the figures and/or description herein, the following reference numerals (Reference Signs List) have been mentioned:
numeral 10 denotes a wall socket, according to one embodiment of the present invention; in contrast to electric wall sockets, this is a water or gas water socket; like electric sockets, this socket as well does not protrude from the wall;
numeral 12 denotes the panel being attached to the building wall;
numeral 14 denotes the handle of the faucet of the wall socket;
numeral 16A denotes the push-to-release pipe-joint being disposed behind the panel;
numeral 16B denotes the push-to-release pipe-joint being partly disposed in front of the panel, and being accessible for quick connection by a non-professional user;
numeral 18 denotes the kitchen or any other room;
numeral 20A denotes the inlet pipe for providing water to the wall socket;
numeral 20B denotes the outlet pipe for supplying water from the wall socket;
numeral 22 denotes the push button, for releasing the pipe from the push-to-release pipe-joint of the wall socket or of a prior art push-to-release pipe-joint;
numeral 26 denotes the springy hook, for tacking the pipe to the push-to-release pipe-joint of the wall socket or to the prior art push-to-release pipe-joint;
numeral 28 denotes the seal, for sealing the pipe to the push-to-release pipe-joint of the wall socket or to the prior art push-to-release pipe-joint;
numeral 30 denotes the end of the push button of the push-to-release pipe-joint of the wall socket or of the prior art push-to-release pipe-joint;
numeral 32 denotes a housing pipe;
numeral 38 denotes a faucet of the wall socket;
numeral 40 denotes an implement needing water or gas supply;
numeral 42 denotes a piping splitting element;
numeral 44 denotes the water source; it is represented by a faucet;
numeral 50 denotes the building wall;
numeral 52A denotes the side of the panel, facing the building wall;
numeral 52B denotes the side of the panel, opposing the building wall, and being exposed to the user;
numeral 56 denotes installation means for installing the panel to the building wall; the connection means may constitute a connection box, being similar to a connection box, into which an electrical socket is installed;
numeral 58 denotes an opening in the building wall;
numeral 60 denotes a tap;
numeral 62 denotes a working surface, such as of a kitchen; the wall socket of the present invention eliminates the need to make a hole in the working surface, for supplying water to the implement; thus the wall socket constitutes a preparation to the kitchen, making the installation of the implement, and removal thereof, immediate;
numeral 64A denotes the inlet of the wall socket; and
numeral 64B denotes the outlet of the wall socket.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A wall socket (10), comprising:
an inlet (64A), for connecting an inlet pipe (20A) thereto;
a first push-to-release pipe-joint (16B), comprising an outlet (64B), for pushing thereinto an outlet pipe (20B), for connecting said outlet pipe (20B) thereto;
a panel (12) disposed between said inlet (64A) and said outlet (64B), and extending from said first push-to-release pipe-joint (16B); and
installation means (56) for installing said panel (12) to a building wall (50), attached thereto and parallel thereto, thereby disposing said inlet (64A) behind the building wall (50, and said outlet (64B) in front of the building wall (50),
wherein said first push-to-release pipe-joint (16B) comprises a joint for connecting the water pipe (20B) thereto by pressing the water pipe (20B) thereinto, and for releasing the water pipe (20B) therefrom by pressing a push button (22) thereof, and
wherein said panel (12) is proximate to said push button (22),
thereby allowing providing a removable supply to an implement (40) by said pressing of the outlet pipe (20B) into said wall socket (10), and
thereby said wall socket (10) non-significantly protrudes out of the building wall (50).

2. A wall socket (10) according to claim 1, wherein said inlet (64A) comprises a second push-to-release pipe-joint (16B), for connecting said inlet pipe (20A) thereto.

3. A wall socket (10) according to claim 1, wherein said panel (12) is rigidly fixed to said push-to-release pipe-joint (16B),
thereby said pressing of the outlet pipe (20B) into said wall socket (10) ensures said connection of said outlet pipe (20B) into said first push-to-release pipe-joint (16B).

4. A wall socket (10) according to claim 1, wherein said inlet (64A) comprises a water inlet, and wherein said outlet (16B) comprises a water outlet, thereby allowing providing water supply to the implement (40).

5. A wall socket (10) according to claim 1, wherein said inlet pipe (20A) is disposed behind the building wall (50),
thereby allowing supplying water from a water source (44) disposed below a working surface (62), to the implement (40) disposed above the working surface (62), through said inlet pipe (20A), without making a hole in the working surface (62).

6. A wall socket (10), according to claim 1, wherein said installation means (56) for installing said panel (12) to the building wall (50), attached thereto and parallel thereto, comprises a connection box (56), for being inserted into an opening (58) in the building wall (50).

7. A wall socket (10) according to claim 1, further comprising:
a faucet (38) for allowing passage from said inlet (64A) to said outlet (64B).

8. A wall socket (10) according to claim 7, further comprising:
a handle (14) for operating said faucet (38),
wherein said panel (12) is disposed between said inlet (64A) and said handle (14),
thereby said handle (14) is accessible upon installation of said wall socket (10) to the building wall (50).
